(19) United States
(12) Patent Application Publication
(10) Pub. No.: US 2002/0147521 A1
(43) Pub. Date: Oct. 10, 2002

(54) Prototype production system and method

(75) Inventors: Steven Siong Cheak Mok, Singapore (SG); Yew Hing Chong, Singapore (SG); Teck Keong Bong, Singapore (SG); Da Jun Toh, Singapore (SG)

Correspondence Address: IPSOLON LLP, 805 SW BROADWAY, #2740, PORTLAND, OR, 97205, US

(73) Assignee: Milling Systems and Concepts Pte Ltd., Singapore (SG)

(21) Appl. No.: 10/045,540

(22) Filed: Oct. 26, 2001

Related U.S. Application Data
(60) Provisional application No. 60/275,873, filed on Mar. 14, 2001.

(51) Int. Cl. G06F 19/00

(52) U.S. Cl. 700/159; 700/118; 700/119

(57) ABSTRACT

A prototype production system, comprising: a plurality of machining apparatuses for carrying out respective manufacturing processes on a prototype; a device for transporting the prototype between the machining apparatuses and positioning the prototype appropriately for each of the respective manufacturing processes to be carried out; and a processor having means to receive prototype data specifying a prototype and means to deconstruct the production of the prototype into a series of manufacturing processes to be performed by respective machining apparatuses.

THIS INVENTION relates to an apparatus and method for creating prototypes, and in particular for the rapid creation of one or more prototypes simultaneously.

Most commercialized rapid prototyping (RP) systems currently found in the market are based upon a material additive, layered manufacturing principle. Examples of such systems are selective laser sintering and fused deposition manufacturing. In use of such systems, computer-aided-design (CAD) models representing objects to be created are first decomposed into thin cross-sectional layer representations. Physical parts corresponding to these cross sectional layer representations are then built up in custom fabrication machines, layer-by-layer, using material additive processes. Layers of support structures may also be simultaneously built up, to fix and support the growing shape of the prototype.

Each commercialized RP system has its own unique strengths, which may relate to material properties, part specifications, total fabrication times, accuracy, cost or specific applications. In general, each such commercialized RP system is geared to producing a certain type of prototype, and is well-adapted for this task.

Generally, RP systems of the type described above are designed to fabricate only one prototype at a time. Multiple prototypes may be fabricated in the same operation, but only if all of the control parameters of the multiple prototypes are identically defined.

Even though most commercialized RP processes are partially automated, setting up of some necessary pre-processes and parameters (such as file transfer from a customer to the RP system) and post-processes (such as sintering and polishing) must still be manually performed by technicians.

Hence, present RP systems are relatively slow, inefficient and labour-intensive. It is an object of the present invention to provide a prototype production system that alleviates some or all of these drawbacks.

Accordingly, one aspect of the present invention provides a prototype production system, comprising: a plurality of machining apparatuses for carrying out respective manufacturing processes on a prototype; a device for transporting the prototype between the machining apparatuses and positioning the prototype appropriately for each of the respective manufacturing processes to be carried out; and a processor having means to receive prototype data specifying a prototype and means to deconstruct the production of the prototype into a series of manufacturing processes to be performed by respective machining apparatuses.

Advantageously, the means to deconstruct the production of the prototype into a series of manufacturing processes comprise means to recognise at least one standard feature in the specified prototype.

Preferably, the system further comprises means to remove data relating to the at least one standard feature from the prototype data and to store feature data relating to the at least one standard feature on a storage means.

Conveniently, the system further comprises means to create instructions for the production of the standard feature on the prototype.

Advantageously, the instructions define a part of the series of manufacturing processes to be performed by respective machining apparatuses.

Preferably, the means to deconstruct the production of the prototype into a series of manufacturing processes comprises means to convert the prototype data into a plurality of sets of layer data, each of which specifies a layer of the prototype.

Conveniently, the means to convert the prototype data into a plurality of sets of layer data comprise means to specify a build direction of the prototype.

Advantageously, the means to convert the prototype data into a plurality of sets of layer data further comprise means to identify at least one planar surface substantially perpendicular to the build direction of the prototype, and to store surface data relating to the at least one planar surface on the storage means.

Preferably, the means to convert the prototype data into a plurality of sets of layer data further comprise means to identify the distances of elements of the specified prototype from a build plane in the build direction, and to store build data relating to the distances of the elements from the build plane in the build direction on a storage means.

Conveniently, the means to convert the prototype data into a plurality of sets of layer data comprise means to vary the thickness of the layers of the prototype specified by the layer data, in dependence upon the dimensions of the prototype defined by the prototype data or upon the capabilities of the machining apparatuses.

Advantageously, the processor comprises means to create, for each of the sets of layer data, instructions for the production of the layer defined by the layer data by the machining apparatuses.

Preferably, the instructions define at least a part of the series of manufacturing processes to be performed by respective machining apparatuses.

Conveniently, the system further comprises means to check the availability of further machining apparatuses and determine that at least some of the manufacturing processes are to be carried out by the further machining apparatuses.

Advantageously, the system further comprises means to estimate a time or date by which production of the prototype will be complete, and generating output containing the time or date.

Preferably, the processor comprises means to estimate the time required to perform each of the series of manufacturing processes.

Conveniently, the system is operable to work on the production of more than one prototype at a time, and wherein the processor comprises means to coordinate the movement of respective prototypes between the machining apparatuses.

Advantageously, the system is operable to work on more than one prototype, each prototype having significantly different production parameters, at a time.

Preferably, the processor is operable to receive data specifying at least one further prototype during production of the prototype.

Conveniently, the machining apparatuses operate under the control of the processor.

Advantageously, at least one of the plurality of machining apparatuses for carrying out respective manufacturing processes on a prototype are selected from the group comprising: a tool carrying apparatus; a material deposition apparatus; and a material removal apparatus.

Preferably, the machining apparatuses comprise at least one of: a micro engraving system; a machining center; a grinder; a lather; a laser cutting system; an extrusion system for plastic, metal or ceramic; a reaction injection moulding system; a hot wax dispensing system; an ultra-violet curing system; a thermal spraying system; a welding system; a laser cladding system; a 5-axis milling system; a micro-milling system; an electrode discharge machine; a CNC machine; a drill and tap system; a cleaning system; a quick-embedding system; a shot-peening system; a measuring system; wax-removal system and a heat-treatment system.

Conveniently, the processor is located in a computer or server attached to the Internet.

Advantageously, the means to receive data specifying a prototype are operable to receive the data specifying the prototype in the form of a CAD file, a point cloud from a 3-D digitiser, or descriptive text from a user.

Preferably, the device for transporting the prototype between the machining apparatuses comprises a twin palletising mechanism or a multiple palletising mechanism.

Conveniently, at least one of the plurality of machining apparatuses for carrying out respective manufacturing processes on a prototype is selected from the group comprising: a tool changing mechanism; an integrated headstock; and a modular fixturing mechanism.

Another aspect of the present invention provides a method of producing a prototype, comprising the steps of: receiving prototype data specifying a prototype; deconstructing the production of the prototype into a series of manufacturing processes to be performed by respective machining apparatuses; and performing the manufacturing processes to produce the prototype.

Advantageously, the method further comprises the steps of: providing a plurality of machining apparatuses for carrying out respective manufacturing processes on a prototype; and providing a device for transporting the prototype between the machining apparatuses and positioning the prototype appropriately for each of the respective manufacturing processes to be carried out.

Preferably, the step of providing a plurality of machining apparatuses comprises the step of providing at least one of the group comprising: a tool carrying apparatus; a material deposition apparatus; and a material removal apparatus.

Conveniently, the step of providing a plurality of machining apparatuses comprises the step of providing at least one of: a micro engraving system; a machining center; a grinder; a lather; a laser cutting system; an extrusion system for plastic, metal or ceramic; a reaction injection moulding system; a hot wax dispensing system; an ultra-violet curing system; a thermal spraying system; a welding system; a laser cladding system, a 5-axis milling system; a micro-milling system; an electrode discharge machine; a CNC machine; a drill and tap system; a cleaning system; a quick-embedding system; a shot-peening system; a measuring system; wax-removal system and a heat-treatment system.

Advantageously, the step of deconstructing the production of the prototype into a series of manufacturing processes comprises the step of recognising at least one standard feature in the specified prototype.

Preferably, the step of removing data relating to the at least one standard feature from the prototype data and storing feature data relating to the at least one standard feature on a storage means.

Conveniently, the method further comprises the steps of: creating instructions for the production of the standard feature on the prototype; and performing manufacturing processes in accordance with the instructions to create the standard feature on the prototype.

Preferably, the step of deconstructing the production of the prototype into a series of manufacturing processes comprises the step of converting the prototype data into a plurality of sets of layer data, each of which specifies a layer of the prototype.

Conveniently, the step of converting the prototype data into a plurality of sets of layer data comprises the step of specifying a build direction of the prototype.

Advantageously, the step of converting the prototype data into a plurality of sets of layer data further comprises the steps of: identifying at least one planar surface substantially perpendicular to the build direction of the prototype; and storing surface data relating to the at least one planar surface on a storage means.

Preferably, the step of converting the prototype data into a plurality of sets of layer data further comprises the steps of: identifying the distances of elements of the specified prototype from a build plane in the build direction; and storing build data relating to the distances of the elements from the build plane in the build direction on a storage means.

Conveniently, the step of converting the prototype data into a plurality of sets of layer data comprises the step of varying the thickness of the layers of the prototype specified by the layer data, in dependence upon the dimensions of the prototype defined by the prototype data or upon the capabilities of the machining apparatuses.

Advantageously, the method further comprises the step of creating, for each of the sets of layer data, instructions for the production of the layer defined by the layer data by machining apparatuses.

Preferably, the instructions define at least a part of the series of manufacturing processes to be performed by respective machining apparatuses.

Conveniently, the method further comprises the steps of: checking the availability of further machining apparatuses; and determining that at least some of the manufacturing processes are to be carried out by the further machining apparatuses.

Advantageously, the method further comprises the steps of: estimating a time or date by which production of the prototype will be complete; and generating output containing the time or date.

Preferably, the method further comprises the step of estimating the time required to perform each of the series of manufacturing processes.

Conveniently, the method is applied to the production of more than one prototype at a time, and comprises the step of coordinating the movement of respective prototypes between the machining apparatuses.

Advantageously, the method is applied to the production of more than one prototype, each prototype having significantly different production parameters, at a time.

Preferably, the method further comprises the step of receiving data specifying a further prototype during production of the prototype.

Conveniently, the method comprises the step of providing processing means to receive the prototype data and for controlling machining apparatuses.

Advantageously, the step of providing processing means comprises the step of providing processing means located in a computer or server attached to the Internet.

Preferably, the step of receiving data specifying a prototype comprises the step of receive data specifying a prototype in the form of a CAD file, a point cloud from a 3-D digitiser, or descriptive text from a user.

Conveniently, the step of providing a device for transporting the prototype between the machining apparatuses comprises the step of providing at least one of a twin palletising mechanism and a multiple palletising mechanism.

Advantageously, the step of providing a plurality of machining apparatuses comprises providing at least one of: a tool changing mechanism; an integrated headstock; and a modular fixturing mechanism.

In order that the present invention may be more readily understood, embodiments thereof will now be described, by way of example, in which:

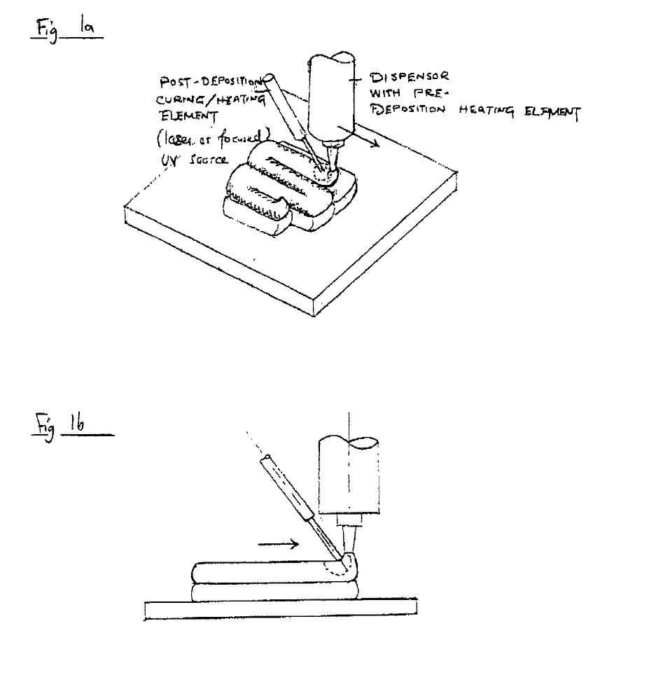

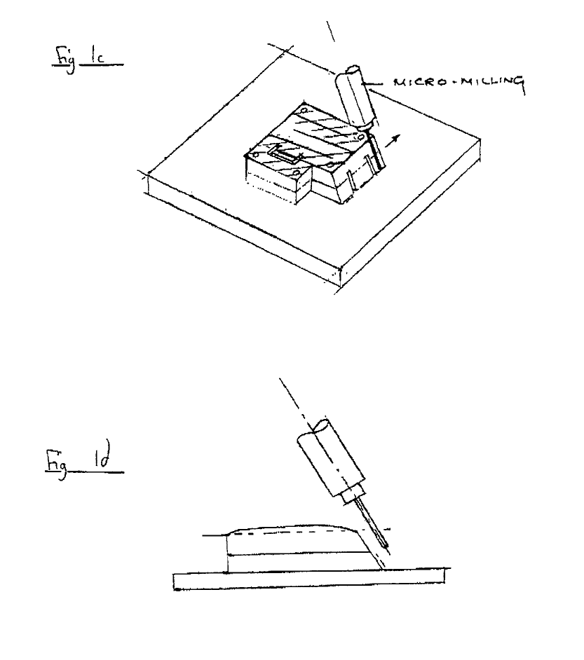

FIGS. 1a and 1b show a step of an adaptive deposition process that may be carried out in a method embodying the present invention;

FIGS. 1c and 1d show a step of a profiling process that may be carried out in a method embodying the present invention;

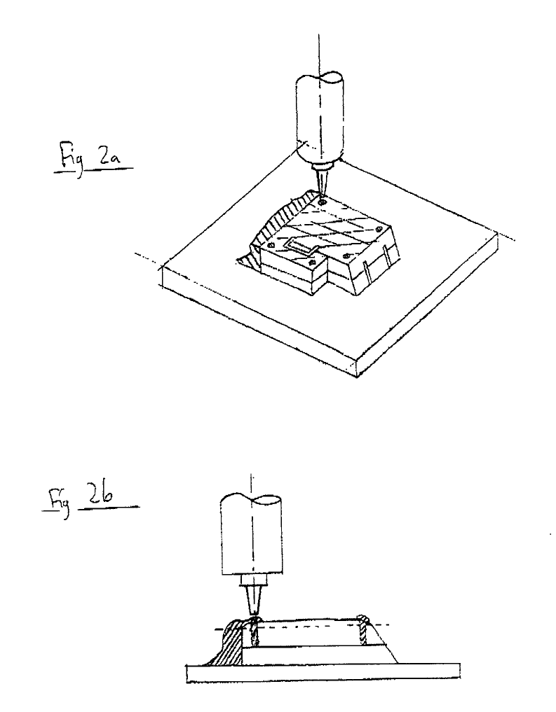

FIGS. 2a and 2b show a step of support material deposition that may be carried out in a method embodying the present invention;

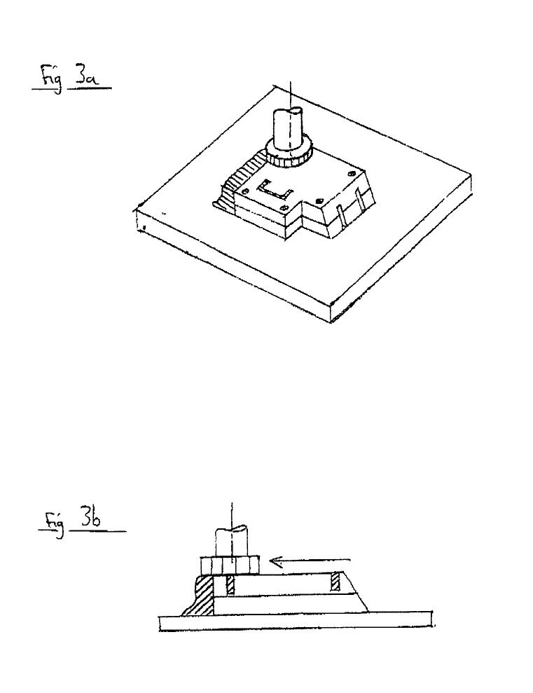

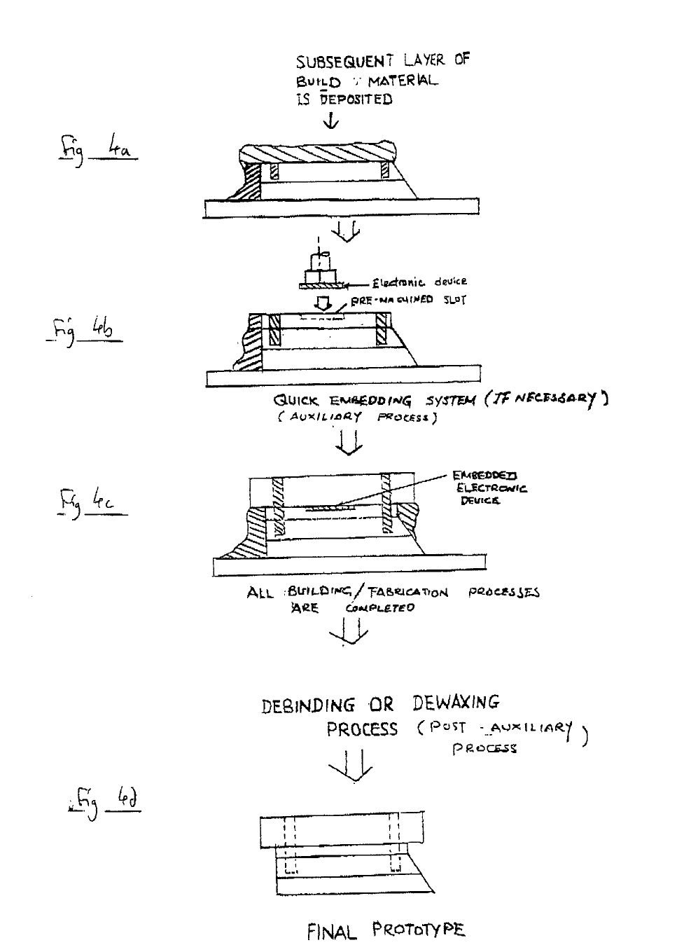

FIGS. 3a and 3b show a step of thickness correction that may be carried out in a method embodying the present invention;

FIGS. 4a to 4d show steps in the fabrication of a plastic, metal or ceramic prototype in a method embodying the present invention;

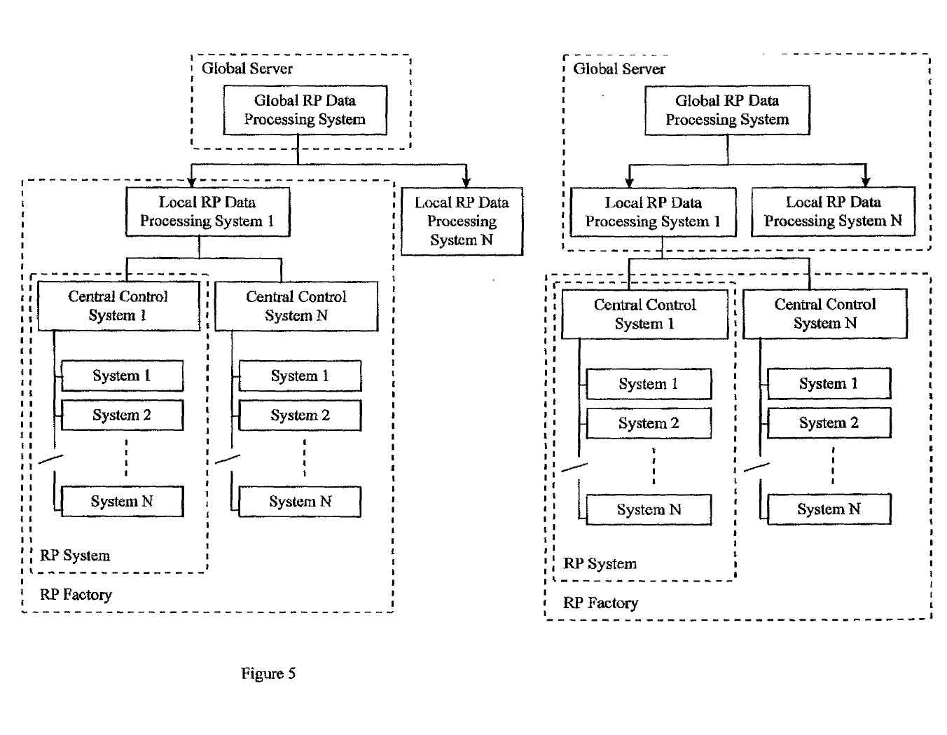

FIG. 5 is a flow chart relating to a one stop integrated rapid prototyping service bureau that may be used with the present invention;

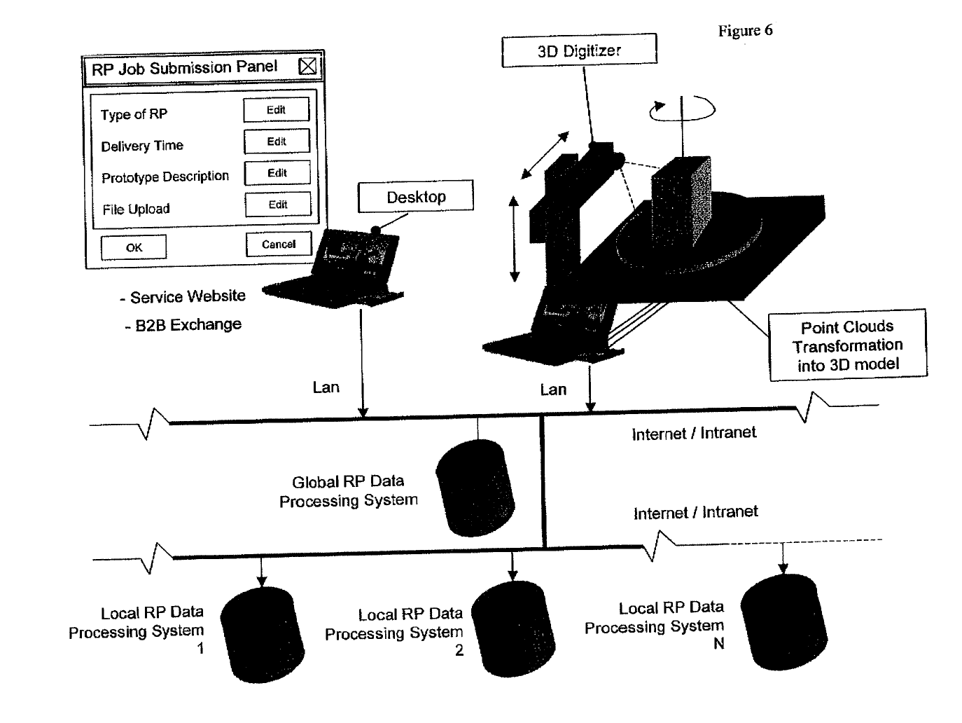

FIG. 6 shows an architecture setup of the one stop integrated rapid prototyping service bureau of FIG. 5;

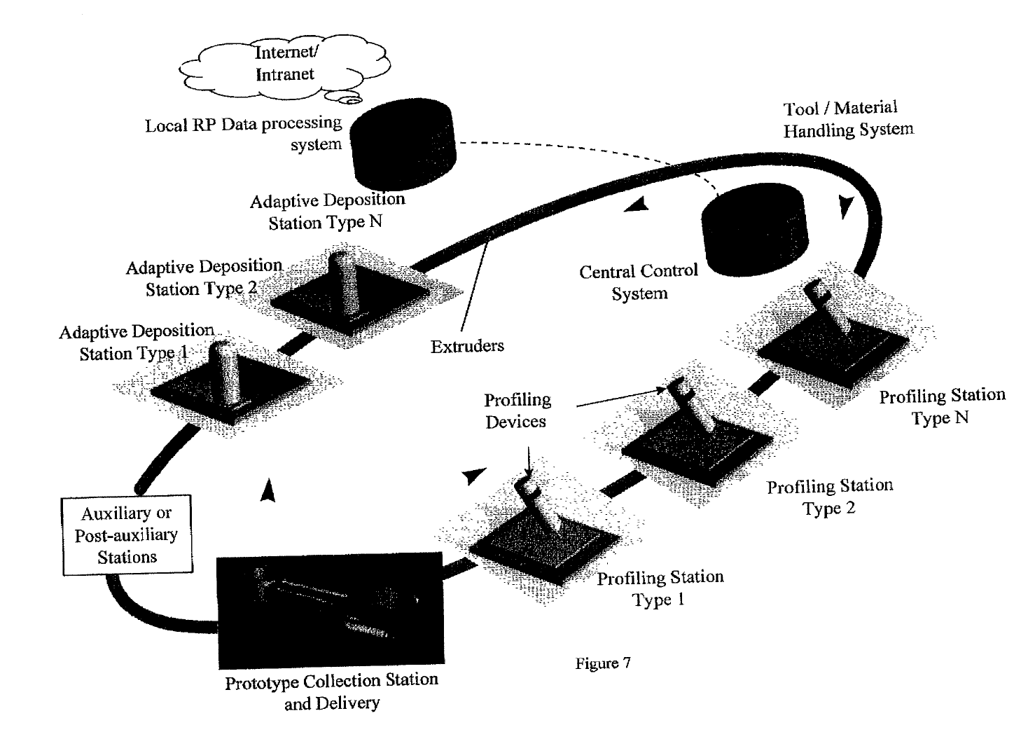

FIG. 7 is a schematic diagram of elements of a rapid prototyping system embodying the present invention;

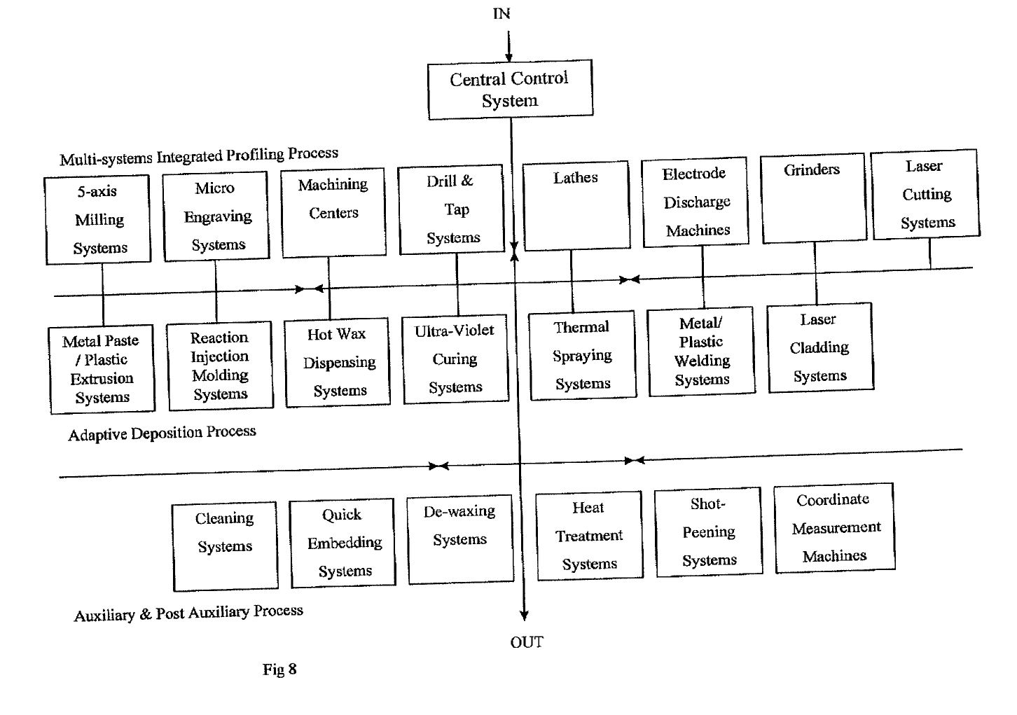

FIG. 8 is a diagram of the integration of various dedicated systems in a rapid prototyping system embodying the present invention;

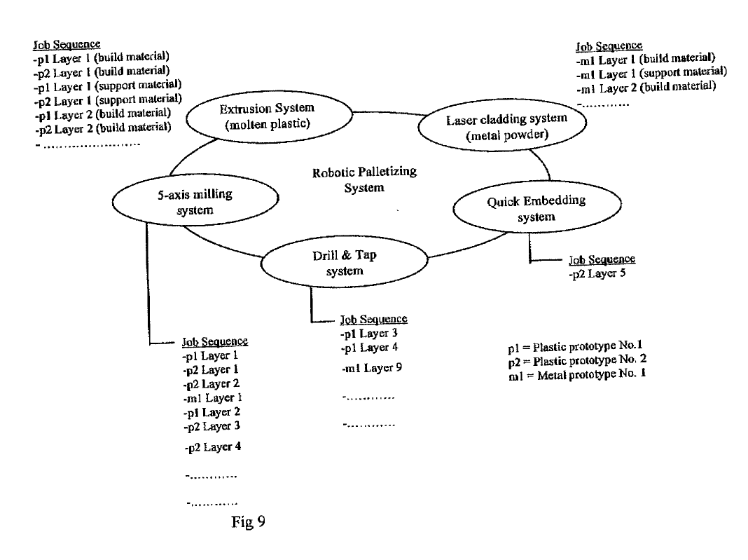

FIG. 9 is a diagram of a job sequence for the fabrication of multiple prototypes by a rapid prototyping system embodying the present invention;

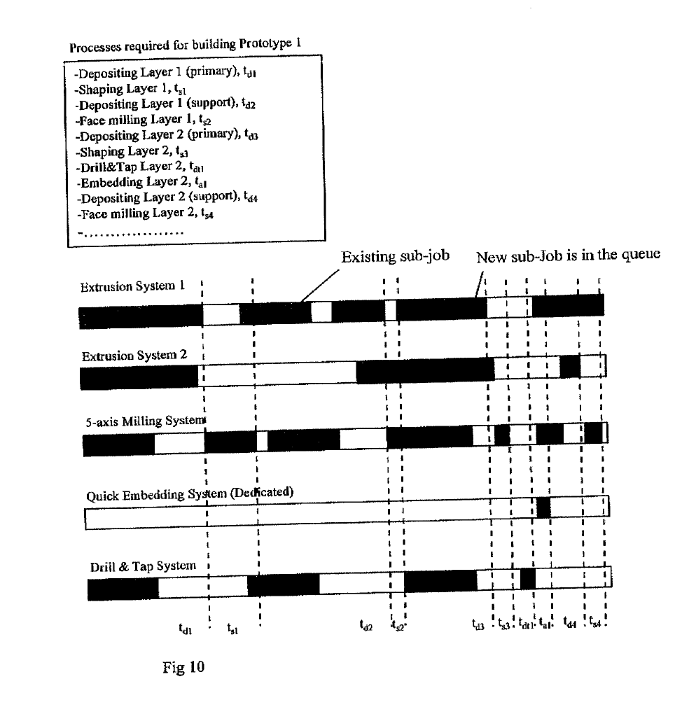

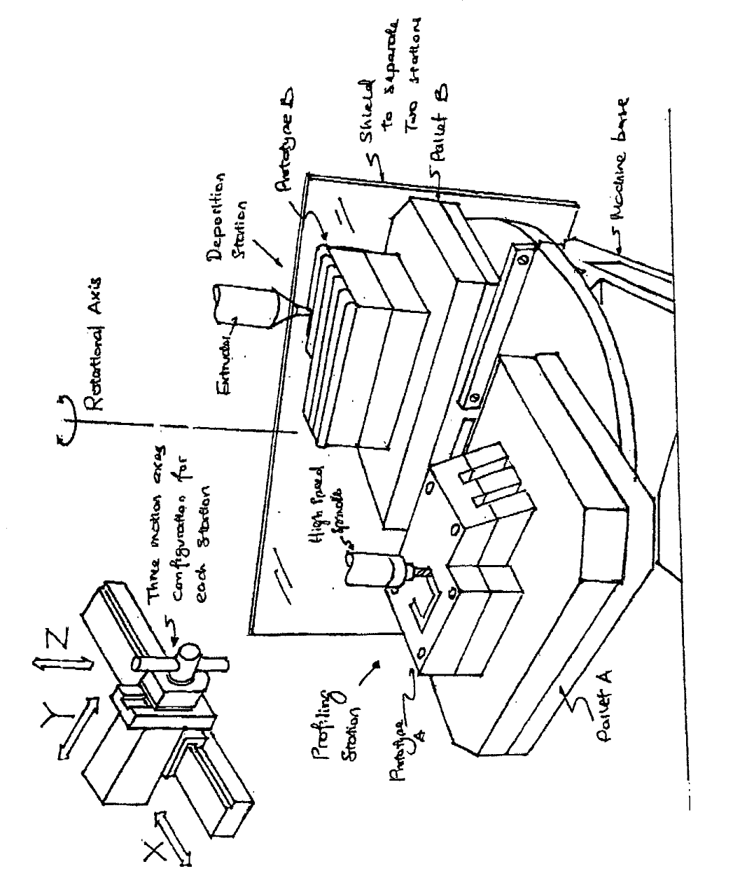

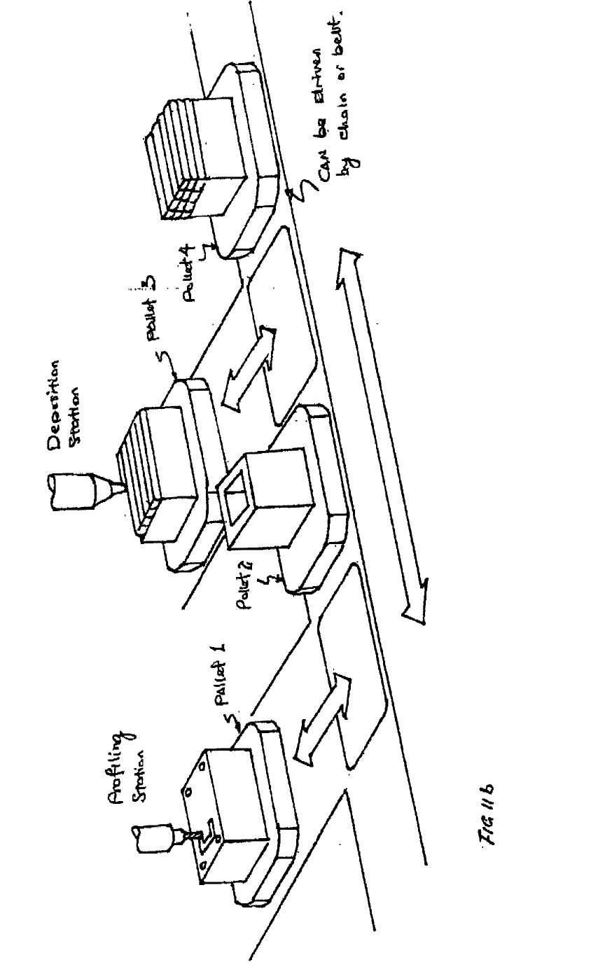

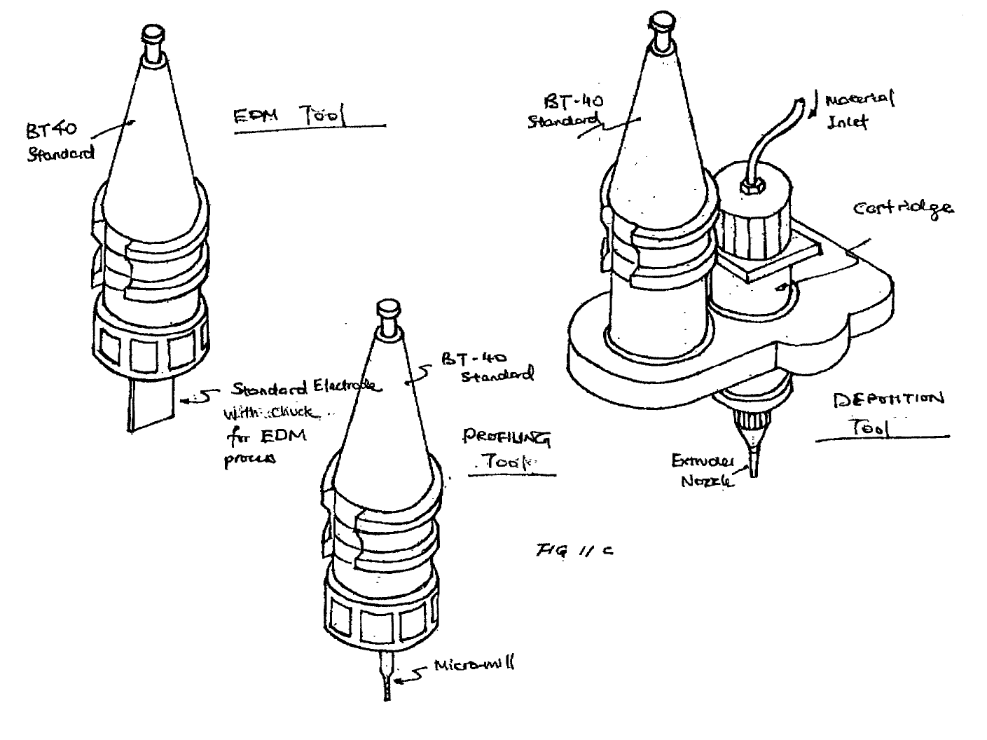

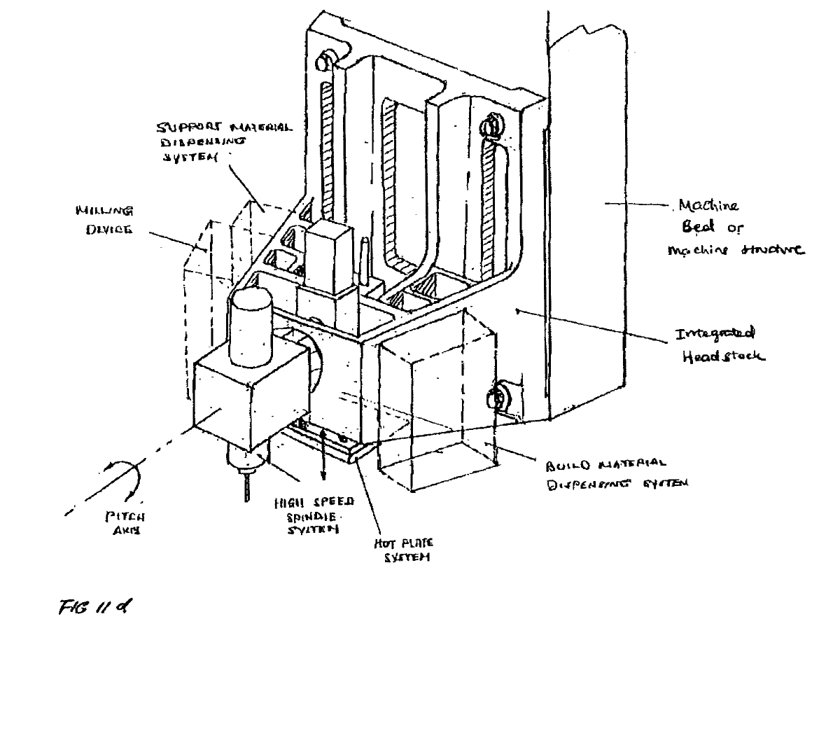

FIG. 10 shows a queuing schedule for prototype fabrication in a central control system that may be used with the present invention;

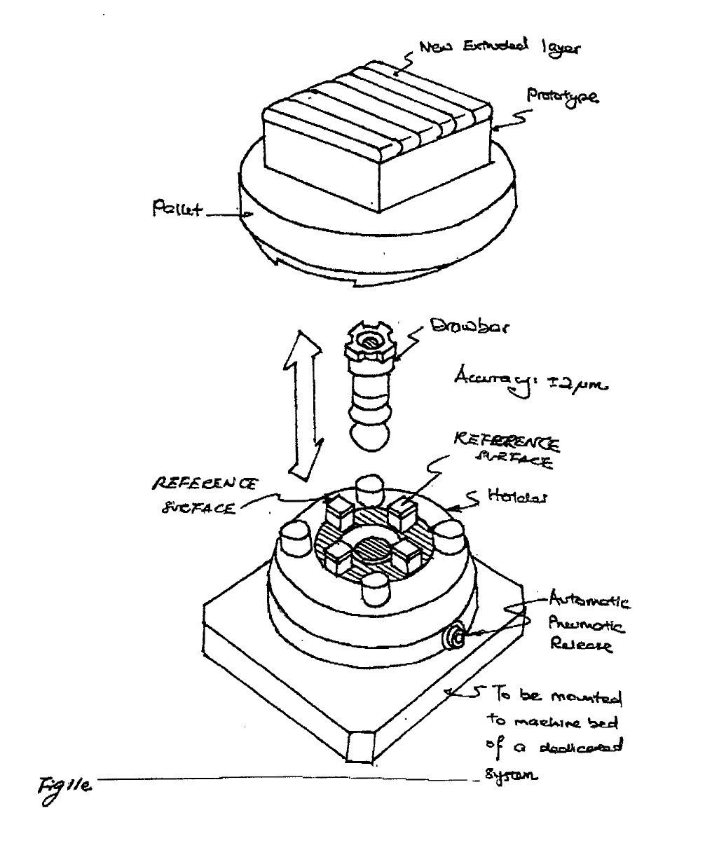

FIG. 11a shows a twin palletising system that may be used with the present invention;

FIG. 11b shows a multiple palletising system that may be used with the present invention;

FIG. 11c shows a tool changing system that may be used with the present invention;

FIG. 11d shows an integrated headstock that may be used with the present invention;

FIG. 11e shows a modular fixturing system that may be used with the present invention;

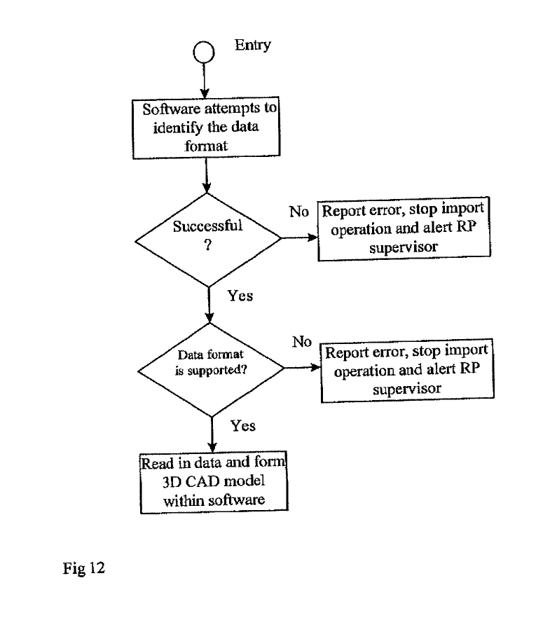

FIG. 12 shows steps in the importation of a 3D CAD model into a global rapid prototyping data processing system that may be used with the present invention;

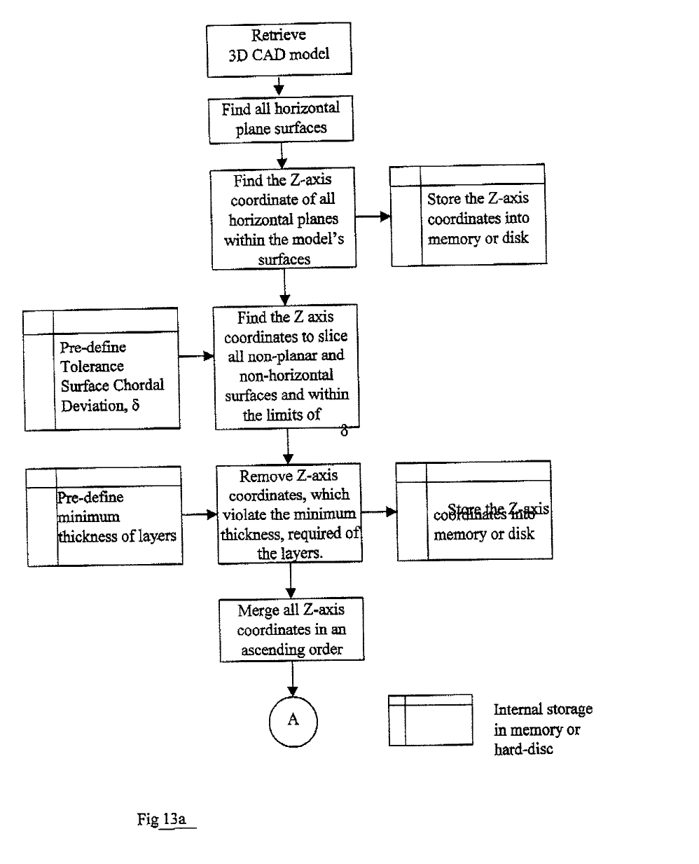

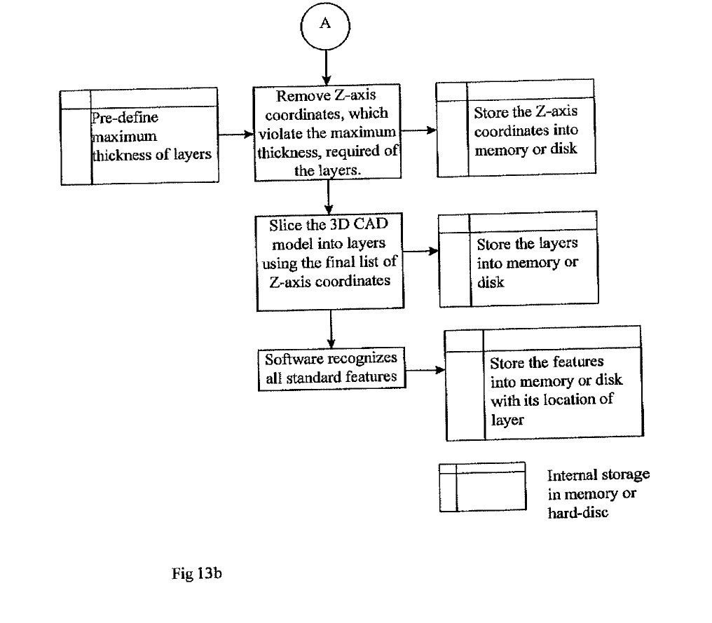

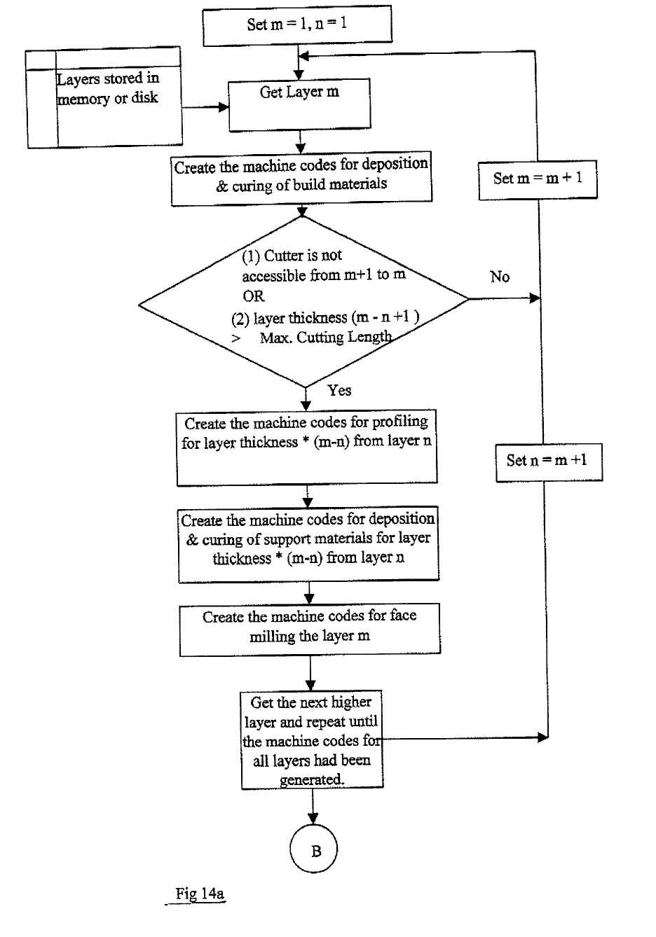

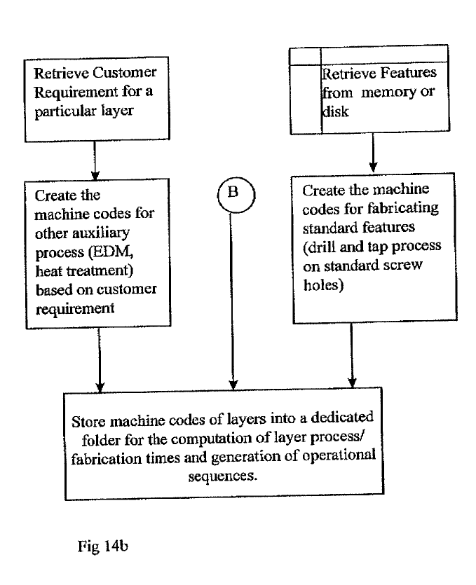

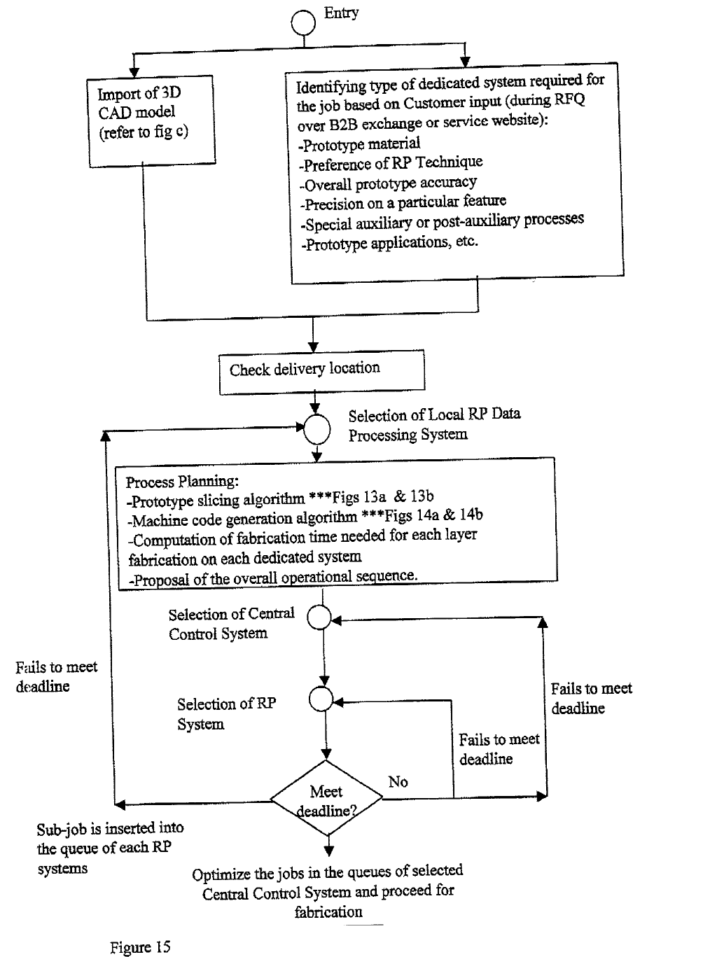

FIGS. 13a and 13b show steps of a prototype slicing algorithm that may be used by a local rapid prototyping data processing system in the carrying out of the present invention;

FIGS. 14a and 14b show steps of a machine code generation algorithm that may be used by a local rapid prototyping data processing system in the carrying out of the present invention; and

FIG. 15 shows steps of an operation algorithm of global and local rapid prototyping data processing systems that may be used in the carrying out of the present invention.

In the modem market place the design of consumer products, particularly electronic and electrical appliances, quickly becomes obsolete with fashion. As a result, manufacturing suppliers attempt to stay competitive by pushing the time to market of a product to the lowest possible limit, and yet manufacturing it economically in small quantities. Unfortunately, these efforts have the effect of further speeding up the changes in fashion.

This phenomenon has driven the manufacturing industry into a new era, which has been called mass customization. “Customization” in this context simply means making products to order to suit a particular customer's needs or preferences, while mass customization is a manufacturing methodology, which allows large varieties of turnkey productions in small quantities.

The present invention provides a new and complete rapid prototyping concept and its associated systems, which allow the building of complex, functional prototypes quickly and accurately.

Shape deposition manufacturing (SDM) is an existing RP process, which combines the advantages of layered manufacturing (an additive process) with the advantages of material removal (a subtractive process).

Layer manufacturing processes have the strengths of presenting no tool accessibility problems, and allowing the construction of undercut and very complex features. On the other hand, material removal processes have the strengths of providing a high quality of accuracy and finishing and offering much shorter fabrication times than layer manufacturing process.

Preferred embodiments of the RP system of the present invention adopts the basic fabrication methodology of SDM, which generally deposits individual layers of a part, and of support material structure, as near-net shapes. Next, each such layer is profiled to a net-shape before additional material is deposited and profiled. The thickness of each layer is adaptively defined in accordance taking into account model geometry, cutter accessibility and effective cutter length.

Preferred embodiments of the present invention provide a RP system which is fully automated, meaning that drawings or data files submitted through the Internet or data (e.g. point cloud data) collected from a 3d digitizer are processed automatically in a secure server. The processing that occurs transforms the customer's drawings or data into a set of instructions for the creation of a prototype, and takes account of customer needs (for instance, model specification, budget, date and place of delivery). Then, the particular prototype job will be sent to the queue of a central control system in a designated RP center. In a preferred embodiment, only the customer is be able to monitor, inspect or verify the process chain.

Further advantageous embodiments of the present invention are able to build plastic, metal and ceramic parts freely without the tedious and time-consuming procedure of equipment set-up, material switching, and so forth, due to the fact that these embodiments adopt a palleting concept combined with the provision of multiple material deposition apparatuses.

The implementation of the palleting concept, which will be described in greater detail below, allows the provision of many kinds of processes, such as profiling, polishing, treatment and measurement of a prototype. The RP system of the present invention may be modular, allowing simple and efficient replacement of apparatuses for existing processes, or implementation of new dedicated apparatus/process into the RP hardware system.

In preferred embodiments of the present invention, a dedicated software architecture is provided. This software architecture is preferably capable of performing some or all of: automatically processing standard formats of engineering files submitted through the Internet and data (point cloud) collected from a 3d digitizer and then transferred through Internet in a secure server; identifying the dedicated systems required to build a 3d functional prototype taking into account the required prototype material, preferences of RP technology, overall required prototype accuracy, precision required for a particular feature, special auxiliary or post-auxiliary processes requested by customer, preference of RP technology, prototype application, delivery location and so forth; planning the actual RP process, which may include prototype slicing, computation of a prototype fabrication sequence and an operational sequence for each layer on each dedicated system; transferring processed data to the queue of a particular RP system in a RP center, with consideration of the availability of required dedicated systems, the queuing time against a requested deadline, and so forth; consolidating and submitting a series of sub-job scopes into queues of respective dedicated systems; optimizing the utility of each dedicated system at every new job received by the particular RP system; updating the customer with the current progress of the fabrication of a prototype in either descriptive text or on-line viewing via a secure web portal; providing data specifications of a functional 3d prototype comprising, for example, material properties or measurement results (i.e. a dimensional check) of a designated part surface which may be sent together with the prototype to the customer; and providing statistical data to further the efficiency of each RP system in different locations based on the market demand of each process, size of the prototype, application of the prototype, and so forth.

The integration of dedicated apparatuses (also called dedicated systems) into a RP system is principally dependent on: the market demand of the processes; the required dedicated systems for a particular process (for example, a metal extrusion RP process may require dedicated systems including an extrusion system, a computer numerically controlled (CNC) system, a shot-peening system and a heat treatment system) and the general processing time for each dedicated system for a particular process (for example, two hot wax dispensing systems and a milling system may be used to perform a certain RP process due to the fact that deposition time is generally much longer than the associated milling operation during fabrication of a layer).

FIGS. 1a-4d illustrate steps in the manufacture of a plastic, metal or ceramic prototype of a predetermined shape by a RP system embodying the present invention.

Firstly, a build material is heated by a pre-deposition heating element, for instance a heating coil (not shown) to a temperature slightly above the melt flow temperature thereof. Once this temperature has been reached, the build material may be deposited.

The build material is deposited in an adaptive deposition process in which, as illustrated in FIGS. 1a and 1b, a dispenser with a pre-deposition heating element extrudes molten build material in accordance with a predetermined material path. The next step is the curing or heating up of the deposited build material with a post-deposition curing/heating element (e.g. an ultra-violet light source or a solid state laser, not shown) to a prescribed temperature to solidify the build material to a machinable condition.

Next, the RP system performs a profiling process, which may involve several integrated RP systems. In FIGS. 1c and 1d show, by way of illustration, a micro cutter milling the deposited build material to the exact shape and size required to form a prototype.

Support material may be deposited with a support material dispenser at locations required to act as support structures for subsequent deposition of further build material, as illustrated in FIGS. 2a and 2b.

FIGS. 3a and 3b show a subsequent step of correcting the thickness of a particular layer using a relatively large flat end mill.

Auxiliary processes may then be performed on the newly built layer. For illustration, as shown in FIGS. 4c and 4d, an electronic device may be embedded into a pre-machined slot in the prototype.

These steps are repeated to build up the required prototype, layer by layer. Finally, post-auxiliary processes may be necessary in which, as illustrated in FIG. 4d, the prototype undergoes a debinding or dewaxing process to remove support material deposited during fabrication thereof.

The particular build material and support material used in the adaptive deposition process are dependent on criteria such as customer preference, the choice of dedicated system, and the compatibility of both materials with one another.

FIG. 5 depicts the flow chart of a one stop integrated RP service bureau. The service bureau comprises a global RP data processing system, local RP data processing systems, central control systems and their dedicated systems (or stations).

As shown in FIG. 5, a local RP data processing system can be implemented in a global server or in a RP factory.

A role of the global RP data processing system is to receive RP jobs from buyers and assign them to local RP data processing systems. A local RP data processing system receives the RP jobs, and then generates a set of operational sequences for production of the prototype defined in the specification of the RP job by the RP systems in a RP factory.

The role of the central control system is to manage the motion controllers of all of the dedicated systems associated therewith. To satisfy this criterion, all controllers, as well as the central control system, are preferably open-architecture integrated to facilitate this control.

FIG. 6 demonstrates a possible architecture set up of the one-stop integrated rapid prototyping (RP) service bureau. Assuming that a request for quotation (RFQ) process has been successfully carried out and a RP job has been assigned to the service bureau, a 3D model can be submitted by a buyer to the service bureau, and this may be done by the uploading of one or more 3D data files or by reverse engineering of a model using a 3D digitizer.

Such a 3D model data file can be uploaded through a service website or via a business-to-business (B2B) exchange/portal. To achieve this, a buyer simply fills in a questionnaire and uploads all related 3D model data files to a RP job submission panel. This information is then encrypted and sent to the service bureau via the Internet or an intranet.

If required, reverse engineering can be performed by collecting point clouds of a model with a 3D Digitizer. These point clouds are transformed into a 3D model and sent to the service bureau via the Internet or an intranet.

The service bureau preferably comprises two types of data processing systems, namely a global RP data processing system and a local RP data processing system.

The global RP data processing system first processes the uploaded 3D models and their RP specifications. This system is able to identify the best central control system of a RP factory to execute a particular RP fabrication. The criteria considered preferably include the requested delivery location, the capability of the RP factory, and the job capacity of the RP factory (e.g. the number of jobs presently undertaken thereby).

Next, a particular 3D model and its RP specifications are forwarded to the chosen local RP data processing system. This system performs a slicing operation on the model, generates appropriate machine codes, computes an estimated fabrication time and produces an operational sequence for each central control system in the selected RP factory.

FIG. 7 shows a schematic drawing of a RP system embodying the present invention. The RP system comprises a central control system, at least one type of profiling station, at least one type of adaptive deposition station, at least one type of auxiliary or post-auxiliary station, a prototype collection station and a tool and/or material handling system to mechanically link all of the stations together.

A local RP data processing system, such as that shown in FIG. 7, is an external system, which generates and updates the operational sequences for at least one of the RP system in a RP factory. The local RP data processing system communicates with the central control system via the Internet or the intranet. The combinations of profiling stations, adaptive deposition stations, and auxiliary or post-auxiliary stations may be grouped together with the consideration of targeted industries, as well as the strengths and usage of the stations.

The tool/material handling system can be implemented with various different mechanisms. One example of such a mechanism is a twin palletizing system, as illustrated in FIG. 11a. Further examples include multiple palletizing and tool changing systems as illustrated in FIGS. 11b and 11c respectively. Alternatively, an integrated headstock may be employed, as shown in FIG. 11d, or a modular fixturing system may be provided, as shown in FIG. 11c. These mechanisms are described in greater detail below.

A prototype collection station allows an operator to collect fabricated RP parts manually.

In a RP operation, new jobs can be individually or jointly assigned to RP systems embodying the present invention at any time. Advantageously, these RP jobs will be seamlessly accommodated into the task queue of the RP system if an empty pallet associated with the RP system is available. This is made possible by each station in a RP system only loading the necessary new machine codes for a particular operation (or layer) if the previous one has been completely executed. The machine codes are preferably directly extracted from the local RP data processing system via the central control system.

Consequently, the local RP data processing system is able to accommodate any new job transferred from the global RP data processing system, thereby updating and improving the overall operational sequence of the RP system.

The local RP data processing system preferably has the ability to manage more than one RP system in a RP factory.

Generally, the fabrication of a prototype is complex, and utilizes the capabilities of more than one station. FIG. 8 shows possible dedicated systems which can be integrated individually or jointly as stations in a RP system embodying the present invention.

The dedicated systems may include 5-axis milling systems which allow additional accessibility to shape slanted or contour surfaces, micro-engraving systems which are operable to engrave micro-features and to perform pencil tracing on prescribed intersection between features, machining centers which remove excess material, drill and tap systems which are operable to perform quick and precision drilling and tapping tasks independently, lathes which machine cylindrical objects independently, electrode discharge machines which are able to features of produce ultra-precise dimensions on a targeted feature, grinders which provide fine polishing of surfaces, and laser cutting systems, which employ lasers to produce parts with very smooth surfaces and burr-free edges, and to give plastic and acrylic materials a “flame-polished” appearance.

Dedicated systems used in an adaptive deposition process for a plastic prototype may include extrusion systems, reaction injection moulding systems, hot wax dispensing system, ultra-violet curing systems and plastic welding systems. Dedicated systems used in an adaptive deposition process for a metal or ceramic prototype may include extrusion systems, thermal spraying systems, welding systems and laser cladding systems.

Brief descriptions of each of these dedicated adaptive deposition systems are given below:

Metal paste and plastic extrusion systems: an extrusion system may be screw-driven and have a heater integrated at the nozzle head. The heater maintains or increases the primary (build) material temperature to its melting point before the material can be dispensed out of the nozzle. The primary material of an extrusion system may be provided in the form of molten liquid, pellets or filament and may be ‘green’ ceramics (e.g. a composition of alumina and silicone nitride), a polycarbonate, or a thermoplastic. The support material of an extrusion system may be a thermoplastic which is non-ionic, water-soluble and machinable.

Reaction injection moulding systems: a reaction injection moulding system generally consists of components such as a polyols reservoir, an isocyanates reservoir and a mixing head. In a reaction injection moulding system, prescribed percentages of polyols and isocyanates are delivered to the mixing head, where a polymerization reaction takes place to transform the mixed solution into a thermoset. This thermoset material has an advantage of emitting heat at a temperature lower than the melting point of a support material. Hence, the shape of the support material will always be retained even if both materials have a direct contact with each other. The support material of the reaction injection moulding system may, for example, be a thermoplastic or a wax.

Hot wax dispensing systems: in such a system, hot wax may be drawn by a piston pump from a melt tank through a heated hose to an extrusion nozzle. The hot wax can be used as either a build material or as a support material, depending upon the particular application. For instance, wax is commonly used as a support material for making parts with resin systems. However, wax parts are often built with the assistance of water soluble, photo curable support materials.

Ultra-violet curing systems: a photo curable resin may be deposited with a syringe pumping system (as described above), and then solidified with the assistance of masked or focused ultra-violet light source. Water-soluble photo curable resin may be used as a support material in a RP system embodying the present invention.

Thermal spraying systems: a thermal spraying system may include plasma sprayers for depositing plastics, metals and ceramics, and two-wire electric systems for depositing metals at a high deposition rate. In production of, for instance, a metal prototype, plasma spraying melts or plasticizes powdered metal into a plasma. Once a plasma plume has been created, a controlled blast propels the plasticized material onto the surface to form a new layer.

Metal and plastic welding systems: a plastic welding system is generally integrated with a hot air blower, a plasticizer unit, an electronic control and a feeder for a plastic rod in a single housing. Separate continuous temperature controls for the plasticizer unit and preheated air may be provided, and the independently controlled plasticizer and preheated air provide advantageous process reliability. Universal extruders are generally provided for material such as ABS, PE-HD, PE-LD, PP, PPS, PVC-U, PVDF, [please provide explanations of these acronyms] and Nylon. The deposition of steel alloys can be performed by using metal inert gas (MIG) welding at a relatively high deposition rate.

Laser cladding systems: laser cladding is a type of laser surface treatment process. During this process, an alloy is fused onto the surface of a substrate. In embodiments of the present invention, laser cladding devices, such as powder feeders, computer numerically controlled CNC workstation tables, laser shutters, and shielding gas controllers, are integrated to make almost any cladding profile possible. The main advantages of laser cladding are low required heat input, a low required degree of mixing, high precision of the applied layers and weldability of almost all metallic alloys. Alloys with either the same or different compositions as the base material can be used as the additional material.

Dedicated systems used in the auxiliary processes and post-auxiliary processes may include: cleaning systems to prepare clean or appropriate surface for subsequent processes, such as coating, measuring, or quick embedding; quick-embedding systems, which embed mechanical or electronic devices into the prototype efficiently and accurately; de-waxing systems, which remove support (sacrificial) material or binder from the prototype by heat or using water or on alternating chemical solvent; heat treatment systems, which heat treat or fire a metal or ceramic prototype in order to gain better material properties, for instance, hardness; shot-peening systems, which release residual stress built up during metal and ceramic RP processes—shot-peening induces a residual compressive stress layer within the part substrate close to a surface of the part in order to reduce or eliminate stress corrosion cracking and crack propagation; and co-ordinate measurement machines which provide dimensional checks on a prescribed feature of a prototype (data provided by a co-ordinate measurement machine is often sent to the buyer together with the prototype itself).

FIG. 9 shows a job sequence for multiple prototype fabrication in a simplified RP system (a so-called “RP module”) embodying the present invention. For illustration, prototypes are built up on pallets, which are transferred among dedicated systems using a robotic palletizing system. Each dedicated system preferably has an individual pallet receiver mechanism. A part transfer robot places a pallet on the pallet receiver mechanism, which locates and clamps the pallet in place. The pallet receiver mechanism in each dedicated system is hydraulically driven and is able to repeatedly locate a pallet to within approximately 2-5 microns of a predetermined location.

In FIG. 9, the RP module consists of five dedicated systems, namely an extrusion system for molten plastic or green ceramics deposition, a laser cladding system for metal powder deposition and fusion, a 5-axis milling system for profiling process, a drill and tap system for performing standard drill and tap features machining, and a quick embedding system for placing an electronic or mechanical device into the prototype during the layer fabrication process.

Other processing systems, such as a shot-peening system or a cleaning system, may be integrated if necessary. Additional systems falling within a similar category, for instance an ABS extrusion system or a Nylon extrusion system, may be integrated if relatively high volumes of both materials are required in the fabrication processes. An extrusion system may be provided with multiple dispensing heads as shown in FIG. 11d, which provide multiple material depositions. More than one dedicated system of a single type may be included if the RP system encounters a bottleneck at a particular fabrication step.

Advantageously, this simplified RP system can be operated on a constant 24-hour basis. Preferably, the RP system consistently communicates with the local RP data processing system via the Internet or an intranet and receives new RP job assignments while operating on existing jobs. Information received by the RP system for a particular job may include machine codes, fabrication times and operational parameters of the job. For every new job received by a particular RP system, usage of each dedicated system will be monitored and controlled at the local RP data processing system.

FIG. 10 shows a sample queuing schedule of a prototype fabrication for a particular RP system. A series of sub-jobs for fabrication of a prototype is consolidated and submitted to a RP system. Each sub-job is assigned to a dedicated system and allocated a time based upon the schedule of the dedicated system.

FIGS. 11a-11e, as discussed above, show various tool/material handling systems, which allow various tools to perform profiling, deposition or auxiliary processes on a prototype.

FIG. 11a shows a twin palletizing mechanism, in which three-axis or five-axis motion drives are externally integrated with a machine table. An additional rotational axis motion drive is integrated onto the machine table to allow the transportation of pallets between two stations. As shown in FIG. 11a, Prototype A on pallet A undergoes a profiling process while prototype B on pallet B undergoes a deposition process. The profiling and deposition stations are separated with a shield to prevent heat transfer and machine chip contamination therebetween.

FIG. 11b shows a multiple palletizing mechanism, in which three-axis or five-axis motion drives are also externally integrated within a machine table. The transportation of pallets is facilitated by a conveyor system, which can be gear-train or belt driven. The conveyor system is generally constructed in a line or carousel arrangement. For illustration, FIG. 11b demonstrates a conveyor system with a line arrangement, in which a total of four prototypes are under fabrication. An automatic fixing system is required for each pallet to be located at each machine to within a tolerance of ±5 microns The multiple palletizing mechanism is more flexible than the above-described twin palletizing mechanism, allowing alteration of either the number of stations or the number of pallets.

FIG. 11c shows a tool changing mechanism, in which a change of process to be performed on a prototype is achieved solely by changing the tools of a single station. The tool handling system is designed for the fabrication of a single prototype. Multiple RP fabrication can be achieved by implementing the above-described twin or multiple palletizing mechanism into the system. FIG. 11c depicts an electrode discharge machine (EDM) tool, a profiling tool and a deposition tool, which are tool change enabled in compliance with the BT40 Standard. This mechanism is suitable for the implementation of multiple profiling tools or multiple deposition tools.

FIG. 11d illustrates an integrated headstock mechanism, in which multiple tools are mounted onto a single headstock. Similarly, this tool handling system is designed for the fabrication of a single prototype. Multiple RP fabrication can again be achieved by implementing the twin or multiple palletizing mechanism into the system. In FIG. 11d, the headstock is integrated with a build material dispensing system, a hot plate system, a high speed spindle system, a milling device and a support material dispensing system. The implementation of such a mechanism is relatively easy when compared to other mechanisms, but the tools or devices mounted on the headstock consume a relatively large amount of space, thereby indirectly sacrificing the travel distance of at least one motion axis drive.

FIG. 11e shows a modular fixturing mechanism, in which a prototype on a pallet is transferred manually from one station to another. For illustration, such a mechanism may comprise a drawbar and some reference surfaces, which are able to locate the pallet efficiently with a tolerance of ±2 microns. A vacuum chuck with reference co-ordinate fixtures may also be implemented as an alternative mechanism for pallet location. Consequently, in this case, integration to link dedicated systems with a palletizing mechanism is not necessary.

FIG. 12 shows an import mechanism for importing a 3D model into a global RP data processing system embodying the present invention. The data format in which the 3D model is stored is first identified. If the system fails to recognize the imported data format, an error report will be generated and a RP supervisor will be alerted.

Next, the system performs a check on the data format of the imported data against a list of data formats supported by the system. If the system does not support the data format, an error report will again be generated and the RP supervisor will be alerted. If the imported data format is successfully recognised and supported, the system then reads in the data and forms a 3D model.

FIGS. 13a & 13b show a prototype slicing algorithm in a local RP data processing system embodying the present invention. Firstly, a 3D CAD model (which, as described above, may be received directly from a buyer or created from a physical model using a 3D digitizer) is loaded into the system. Next, the system defines horizontal plane surfaces of the model. The locations of these horizontal plane surfaces are dependent on the orientation of the model to system reference planes.

These horizontal plane surfaces and their respective Z-axis co-ordinates within the model surfaces are then located. These horizontal plane surface Z-axis co-ordinates are stored into a memory, which may be a hard disk on other internal storage device.

Next, a slicing simulation is performed on the model at Z-axis coordinates, starting from the base and progressing towards the top of the model, wherever a non-planar or a non-horizontal surface is detected. However, the slicing will be restricted if the layer thickness or the difference between two adjacent such Z-axis co-ordinates is less than or equal to a user-defined tolerance surface chordal deviation.

The slice simulations are checked against a user-defined minimum layer thickness and a maximum layer thickness sequentially. Any slice simulations which violate the criteria are filtered. If necessary, a new list of layer slicing information is updated in the memory. The 3D model is then sliced into layers, based upon the final list of layer slicing information. The specification of each layer is then stored into the memory accordingly.

After the prototype slicing is completed, the algorithm recognizes, extracts and stores all standard features from the 3D model into the memory. These standard features may include cylindrical objects, holes, slot, spherical objects, and so forth. This allows the RP system to generate machining process for each of these standard features, rather than fabricating them with deposition processes, which are invariably much slower. Also, dedicated finishing processes for the standard features may be generated so that better finishing and accuracy for these features can be achieved.

The layer slicing information associated with each feature is stored accordingly. This is to assist in the planning of operational sequences, in which it is specifically dictated when the machining process for each feature shall be carried out.

FIGS. 14a & 14b show a machine code generation algorithm of a local RP data processing system.

A layer m is first retrieved from the memory. In the machine code generation algorithm, a variable m is defined as identifying the instantaneous material deposition layer in the computation, while a further variable n is defined as the first new material deposition layer after machine codes of a profiling process have been generated on the previous layer.

By setting m=1 and n=1, the machine codes for deposition and curing of the build material to form layer m are generated.

Next, the cutter accessibility from layer (m+1) to layer m is checked and the layer thickness (m−n+1) is compared against the maximum permissible cutting length. A new layer (m+1) is retrieved only if the cutter is accessible from layer (m+1) to layer (m) and layer thickness (m−n+1) is less than the maximum cutting length. If this is not the case, machine codes for a profiling process for a layer thickness x(m−n) are generated beginning from layer n.

Following that, the machine codes for deposition and curing of the support material for layer thickness x(m−n) are generated beginning from layer n. The generation of machine codes for face milling for layer m is next performed.

Subsequently, the next highest layer is retrieved and the machine code generation processes are repeated (n=m+1 while m=m+1) until the machine codes for all layers are generated.

As well as machine codes for all layers, the algorithm computes machine codes for auxiliary and/or post-auxiliary process, as well as the machine codes for standard feature fabrications which, as described above, are separately stored in the memory.

Ultimately, the machine codes corresponding to each of the layers are documented into a dedicated folder for the computation of layer fabrication times and the generation of operational sequences for the central control system.

FIG. 15 depicts an overview of an algorithm for global and local RP data processing systems embodying the present invention.

Having uploaded a 3D CAD model via the Internet or an intranet, the global RP data processing system first identifies the dedicated systems required for the RP job based on, for example, the prototype material, preference of RP technique, overall prototype accuracy, precision required for a particular feature, special auxiliary or post-auxiliary processes requested by customer and the application of the prototype.

Next, a local RP data processing system is chosen, and preferably the selected system will provide the closest match of dedicated system requirements and the requested delivery location.

In the local RP data processing system, the prototype is sliced into layers with additive thicknesses, as shown in FIGS. 13a and 13b. Each layer is expected to undergo a few machining processes provided by the dedicated systems. Next, machine codes for all processes for each layer are generated, as shown in FIGS. 14a and 14b. This is followed by the computation of the total fabrication time for each layer and the operational sequence for each dedicated system.

A central control system in a RP factory is then selected and the sub-jobs are inserted into the queue of the RP system. Considering existing sub-jobs in the queue, a projected date and time of part completion can then be calculated. This time may also include the prototype delivery time.

If a requested deadline for a prototype fabrication cannot be met in a chosen RP system, the selection of RP system is repeated. It may be necessary to re-select a central control system and sequentially a local RP data processing system if all RP systems in a RP factory fail to meet the delivery deadline.

After identifying an appropriate RP system, those existing RP jobs in the queue of the selected system undergo an optimization or iteration procedure. Lastly, the series of sub-job scopes is consolidated according to the types of dedicated systems present in the RP system in the RP factory.

It will be appreciated that the present invention provides an extremely flexible and efficient prototype production system and method, that allow the simultaneous rapid production of several prototypes with minimal intervention from technicians.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

We claim:

1. A prototype production system, comprising:
a plurality of machining apparatuses for carrying out respective manufacturing processes on a prototype;
a device for transporting the prototype between the machining apparatuses and positioning the prototype appropriately for each of the respective manufacturing processes to be carried out; and
a processor having means to receive prototype data specifying a prototype and means to deconstruct the production of the prototype into a series of manufacturing processes to be performed by respective machining apparatuses.

2. A prototype production system according to claim 1, wherein the means to deconstruct the production of the prototype into a series of manufacturing processes comprise means to recognise at least one standard feature in the specified prototype.

3. A prototype production system according to claim 2, further comprising means to remove data relating to the at least one standard feature from the prototype data and to store feature data relating to the at least one standard feature on a storage means.

4. A prototype production system according to claim 3, further comprising means to create instructions for the production of the standard feature on the prototype.

5. A prototype production system according to claim 4, wherein the instructions define a part of the series of manufacturing processes to be performed by respective machining apparatuses.

6. A prototype production system according to claim 1, wherein the means to deconstruct the production of the prototype into a series of manufacturing processes comprises means to convert the prototype data into a plurality of sets of layer data, each of which specifies a layer of the prototype.

7. A prototype production system according to claim 6, wherein the means to convert the prototype data into a plurality of sets of layer data comprise means to specify a build direction of the prototype.

8. A prototype production system according to claim 7, wherein the means to convert the prototype data into a plurality of sets of layer data further comprise means to identify at least one planar surface substantially perpendicular to the build direction of the prototype, and to store surface data relating to the at least one planar surface on the storage means.

9. A prototype production system according to claim 6, wherein the means to convert the prototype data into a plurality of sets of layer data further comprise means to identify the distances of elements of the specified prototype from a build plane in the build direction, and to store build data relating to the distances of the elements from the build plane in the build direction on a storage means.

10. A prototype production system according to claim 6, wherein the means to convert the prototype data into a plurality of sets of layer data comprise means to vary the thickness of the layers of the prototype specified by the layer data, in dependence upon the dimensions of the prototype defined by the prototype data or upon the capabilities of the machining apparatuses.

11. A prototype production system according to claim 6, wherein the processor comprises means to create, for each of the sets of layer data, instructions for the production of the layer defined by the layer data by the machining apparatuses.

12. A prototype production system according to claim 11, wherein the instructions define at least a part of the series of manufacturing processes to be performed by respective machining apparatuses.

13. A prototype production system according to claim 1, further comprising means to check the availability of further machining apparatuses and determine that at least some of the manufacturing processes are to be carried out by the further machining apparatuses.

14. A prototype production system according to claim 1, further comprising means to estimate a time or date by which production of the prototype will be complete, and generating output containing the time or date.

15. A prototype production system according to claim 12, wherein the processor comprises means to estimate the time required to perform each of the series of manufacturing processes.

16. A prototype production system according to claim 15, wherein the system is operable to work on the production of more than one prototype at a time, and wherein the processor comprises means to co-ordinate the movement of respective prototypes between the machining apparatuses.

17. A prototype production system according to claim 16, wherein the system is operable to work on more than one prototype, each prototype having significantly different production parameters, at a time.

18. A prototype production system according to claim 16, wherein the processor is operable to receive data specifying at least one further prototype during production of the prototype.

19. A prototype production system according to claim 1, wherein the machining apparatuses operate under the control of the processor.

20. A prototype production system according to claim 1, wherein at least one of the plurality of machining apparatuses for carrying out respective manufacturing processes on a prototype are selected from the group comprising: a tool carrying apparatus; a material deposition apparatus; and a material removal apparatus.

21. A prototype production system according to claim 20, wherein the machining apparatuses comprise at least one of: a micro engraving system; a machining center; a grinder; a lather; a laser cutting system; an extrusion system for plastic, metal or ceramic; a reaction injection moulding system; a hot wax dispensing system; an ultra-violet curing system; a thermal spraying system; a welding system; a laser cladding system; a 5-axis milling system; a micro-milling system; an electrode discharge machine; a CNC machine; a drill and tap system; a cleaning system; a quick-embedding system; a shot-peening system; a measuring system; wax-removal system and a heat-treatment system.

22. A prototype production system according to claim 1, wherein the processor is located in a computer or server attached to the Internet.

23. A prototype production system according to claim 1, wherein the means to receive data specifying a prototype are operable to receive the data specifying the prototype in the form of a CAD file, a point cloud from a 3-D digitiser, or descriptive text from a user.

24. A prototype production system according to claim 1, wherein the device for transporting the prototype between the machining apparatuses comprises a twin palletising mechanism or a multiple palletising mechanism.

25. A prototype production system according to claim 1, wherein at least one of the plurality of machining apparatuses for carrying out respective manufacturing processes on a prototype is selected from the group comprising: a tool changing mechanism; an integrated headstock; and a modular fixturing mechanism.

26. A method of producing a prototype, comprising the steps of:
receiving prototype data specifying a prototype;
deconstructing the production of the prototype into a series of manufacturing processes to be performed by respective machining apparatuses; and
performing the manufacturing processes to produce the prototype.

27. A method according to claim 26, further comprising the steps of:
providing a plurality of machining apparatuses for carrying out respective manufacturing processes on a prototype; and
providing a device for transporting the prototype between the machining apparatuses and positioning the prototype appropriately for each of the respective manufacturing processes to be carried out.

28. A method according to claim 27, wherein the step of providing a plurality of machining apparatuses comprises the step of providing at least one of the group comprising: a tool carrying apparatus; a material deposition apparatus; and a material removal apparatus.

29. A method according to claim 28, wherein the step of providing a plurality of machining apparatuses comprises the step of providing at least one of: a micro engraving system; a machining center; a grinder; a lather; a laser cutting system; an extrusion system for plastic, metal or ceramic; a reaction injection moulding system; a hot wax dispensing system; an ultra-violet curing system; a thermal spraying system; a welding system; a laser cladding system, a 5-axis milling system; a micro-milling system; an electrode discharge machine; a CNC machine; a drill and tap system; a cleaning system; a quick-embedding system; a shot-peening system; a measuring system; wax-removal system and a heat-treatment system.

30. A method according to claim 26, wherein the step of deconstructing the production of the prototype into a series of manufacturing processes comprises the step of recognising at least one standard feature in the specified prototype.

31. A method according to claim 30, further comprising the step of removing data relating to the at least one standard feature from the prototype data and storing feature data relating to the at least one standard feature on a storage means.

32. A method according to claim 31, further comprising the steps of:
creating instructions for the production of the standard feature on the prototype; and
performing manufacturing processes in accordance with the instructions to create the standard feature on the prototype.

33. A method according to claim 26, wherein the step of deconstructing the production of the prototype into a series of manufacturing processes comprises the step of converting the prototype data into a plurality of sets of layer data, each of which specifies a layer of the prototype.

34. A method according to claim 33, wherein the step of converting the prototype data into a plurality of sets of layer data comprises the step of specifying a build direction of the prototype.

35. A method according to claim 34, wherein the step of converting the prototype data into a plurality of sets of layer data further comprises the steps of:
identifying at least one planar surface substantially perpendicular to the build direction of the prototype; and
storing surface data relating to the at least one planar surface on a storage means.

36. A method according to claim 34, wherein the step of converting the prototype data into a plurality of sets of layer data further comprises the steps of:
identifying the distances of elements of the specified prototype from a build plane in the build direction; and
storing build data relating to the distances of the elements from the build plane in the build direction on a storage means.

37. A method according to claim 34, wherein the step of converting the prototype data into a plurality of sets of layer data comprises the step of varying the thickness of the layers of the prototype specified by the layer data, in dependence upon the dimensions of the prototype defined by the prototype data or upon the capabilities of the machining apparatuses.

38. A method according to claim 34, further comprising the step of creating, for each of the sets of layer data, instructions for the production of the layer defined by the layer data by machining apparatuses.

39. A method according to claim 38, wherein the instructions define at least a part of the series of manufacturing processes to be performed by respective machining apparatuses.

40. A method according to claim 26, further comprising the steps of:
checking the availability of further machining apparatuses; and
determining that at least some of the manufacturing processes are to be carried out by the further machining apparatuses.

41. A method according to claim 26, further comprising the steps of:
estimating a time or date by which production of the prototype will be complete; and
generating output containing the time or date.

42. A method according to claim 41, further comprising the step of estimating the time required to perform each of the series of manufacturing processes.

43. A method according to claim 42, applied to the production of more than one prototype at a time, and comprising the step of coordinating the movement of respective prototypes between the machining apparatuses.

44. A method according to claim 43, applied to the production of more than one prototype, each prototype having significantly different production parameters, at a time.

45. A method according to claim 43, further comprising the step of receiving data specifying a further prototype during production of the prototype.

46. A method according to claim 26, comprising the step of providing processing means to receive the prototype data and for controlling machining apparatuses.

47. A method according to claim 46, wherein the step of providing processing means comprises the step of providing processing means located in a computer or server attached to the Internet.

48. A method according to claim 26, wherein the step of receiving data specifying a prototype comprises the step of receive data specifying a prototype in the form of a CAD file, a point cloud from a 3-D digitiser, or descriptive text from a user.

49. A method according to claim 27, wherein the step of providing a device for transporting the prototype between the machining apparatuses comprises the step of providing at least one of a twin palletising mechanism and a multiple palletising mechanism.

50. A method according to claim 27, wherein the step of providing a plurality of machining apparatuses comprises providing at least one of: a tool changing mechanism; an integrated headstock; and a modular fixturing mechanism.
